(19) United States
(12) Patent Application Publication
(10) Pub. No.: US 2010/0118226 A1
(43) Pub. Date: May 13, 2010

(54) Liquid crystal display device

(76) Inventor: Ki-Won Kim, Goyang (KR)

Correspondence Address: MCKENNA LONG & ALDRIDGE LLP, 1900 K STREET, NW, WASHINGTON, DC, 20006, US

(21) Appl. No.: 12/591,223

(22) Filed: Nov. 12, 2009

(30) Foreign Application Priority Data
Nov. 12, 2008 (KR) 10-2008-0112416

(51) Int. Cl. G02F 1/1333

(52) U.S. Cl. 349/58

(57) ABSTRACT

A liquid crystal display (LCD) device including: a liquid crystal display panel; a light source provided below the liquid crystal display panel and emitting light to provide the light to the liquid crystal display panel; a light guide plate disposed below the liquid crystal display panel and guiding light emitted from the light source to the liquid crystal display panel; a lower cover accommodating the liquid crystal display panel, the light source and the light guide plate assembled therein; and a bent portion extending from an end portion of the lower cover and bent toward the outer side of the liquid crystal display panel at least once to absorb an impact applied from the exterior. An external impact can be absorbed to prevent damage of the LCD device.

### CROSS-REFERENCE TO RELATED APPLICATION

This application claims priority under 35 U.S.C. 119 to Korean Patent Application No. 10-2008-00112416, filed on Nov. 12, 2008, which is hereby incorporated by reference in its entirety.

### BACKGROUND OF THE INVENTION

1. Field of the Invention

The present invention relates to a liquid crystal display (LCD) device and, more particularly, to an LCD device in which a lower cover extends to effectively absorb an impact applied from the exterior, thus being resistant to an external impact.

2. Description of the Related Art

In general, an LCD includes a liquid crystal display panel including a thin film transistor (TFT) array substrate, a color filter substrate which are attached with a certain gap in a facing manner, and a liquid crystal layer provided in the space between the TFT array substrate and the color filter substrate, a driving unit for driving the liquid crystal display panel, and a backlight unit for providing light to the liquid crystal display panel.

The TFT array substrate includes a plurality of data lines arranged to be separated in a vertical direction and a plurality of gate lines arranged to be separated in a horizontal direction. The plurality of data lines and the plurality of gate lines cross to define pixels. The pixels defined at each crossing of the data lines and the gate lines are arranged in a matrix form.

On the color filter substrate, there are formed red, green and blue color filter layers at positions corresponding to the pixels, and black matrixes formed between the color filter layers to prevent light leakage between the color filter layers and prevent a color interference of light that passes through the pixels.

A common electrode and pixel electrodes are formed on inner facing surfaces of the color filter substrate and the TFT array substrate, respectively, to apply an electric field to the liquid crystal layer. In this case, the pixel electrodes are formed at each pixel on the TFT array substrate, while the common electrode is integrally formed on the entire surface of the color filter substrate. The voltage applied to the pixel electrode is controlled in a state that voltage is applied to the common electrode to change the alignment of liquid crystal molecules of the liquid crystal layer, thus individually adjust light transmittance of the pixels.

The backlight unit supplies light to the LCD device that does not emit light by itself, and the light transmittance is determined by the alignment of the liquid crystals when light emitted from the backlight unit passes through the liquid crystal layer, to display an image.

FIG. 1 is an exploded perspective view schematically showing the structure of the general LCD device, and FIG. 2 is a sectional view of the general LCD device. As shown in FIGS. 1 and 2, the LCD device includes a liquid crystal display panel 10 including a first substrate 1, a second substrate 3 and a liquid crystal layer (not shown) interposed between the first and second substrates 1 and 3, and displaying an image when a signal is applied from the exterior thereto, a light guide plate 20 disposed below the liquid crystal display panel 10 and guide light emitted from a light source (not shown) such as a light emitting diode (LED) or a lamp so as to be supplied to the liquid crystal display panel 10, an optical sheet 30 provided between the liquid crystal display panel 10 and the light guide plate 20 to diffuse and condense light supplied to the liquid crystal display panel after being guided from the light guide plate 20 to thus improve light efficiency, a main support unit 25 disposed under the light guide plate 20 to support the light guide plate 20 and the liquid crystal display panel 10, and a lower cover 40 positioned under the main support unit 25, to which the liquid crystal display panel 10, the light guide plate 20, the optical sheet 30, and the main support unit 25 are assembled.

In addition, a reflector 28 is formed on the lower cover 40 to reflect light made incident to the lower cover 40 to the liquid crystal display panel 10 to improve light efficiency.

Although not shown, a plurality of pixels are provided on the first substrate 1 of the liquid crystal display panel 10. Each pixel includes pixel electrodes and a TFT, and a common electrode is formed on the second substrate 3. When an external signal is applied through the TFT, an electric field is formed in the liquid crystal layer to adjust alignment of liquid crystal molecules to adjust the transmittance of light that passes through the liquid crystal layer to thus display an image. In this case, the first and second substrates 1 and 3 includes polarizers 8 and 9 attached thereon to control a polarization direction of light made incident to the liquid crystal layer and light outputted from the liquid crystal layer.

Edges of the liquid crystal display panel 10 are supportedly placed on the main support unit 25. A pad 36 is formed on the main support unit 25, and the liquid crystal display panel 10 is positioned on the pad 36.

In the LCD device configured as described above, the liquid crystal display panel may be damaged by an impact applied thereto. Namely, when an external force is applied, it is transferred to the liquid crystal display panel to damage it. In particular, the thickness of the substrate made of glass tends to be reduced in line with the trend that the LCD is becoming lighter, so the strength of the liquid crystal display panel is degraded, and accordingly, it may be damaged even by a weak external force applied thereto.

### SUMMARY OF THE INVENTION

Therefore, in order to address the above matters, the various features described herein have been conceived.

An aspect of the present invention provides a liquid crystal display (LCD) device capable of preventing damage to a liquid crystal display panel by effectively absorbing an impact applied from the exterior.

According to an aspect of the present invention, there is provided an LCD device including: a liquid crystal display panel; a light source provided below the liquid crystal display panel and emitting light to supply the light to the liquid crystal display panel; a light guide plate below the liquid crystal display panel to guide the light emitted from the light source to the liquid crystal display panel; a lower cover for receiving and assembling the liquid crystal display panel, the light source and the light guide plate; and a bent portion extending from an end portion of the lower cover and bent toward an outer side of the liquid crystal display panel at least once to absorb an impact applied from the exterior.

The bent portion may be bent three or four times in a quadrangular shape, or may be bent in a circular shape or an ellipse shape.

In an exemplary embodiment of the present invention, because the lower cover includes the bent portion formed by bending an end portion of the lower cover at least once to the outer side to effectively absorb an impact applied from the exterior, the LCD can be prevented from being damaged by the external impact.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing the structure of the related art liquid crystal display (LCD) device;

FIG. 2 is a sectional view showing the structure of the related art LCD device;

FIG. 3 is a sectional view showing the structure of an LCD according to one exemplary embodiment of the present invention;

FIG. 4 is a plan view showing the structure of a liquid crystal display panel of the LCD according to an exemplary embodiment of the present invention; and

FIG. 5 is a sectional view showing the structure of an LCD device according to another exemplary embodiment of the present invention.

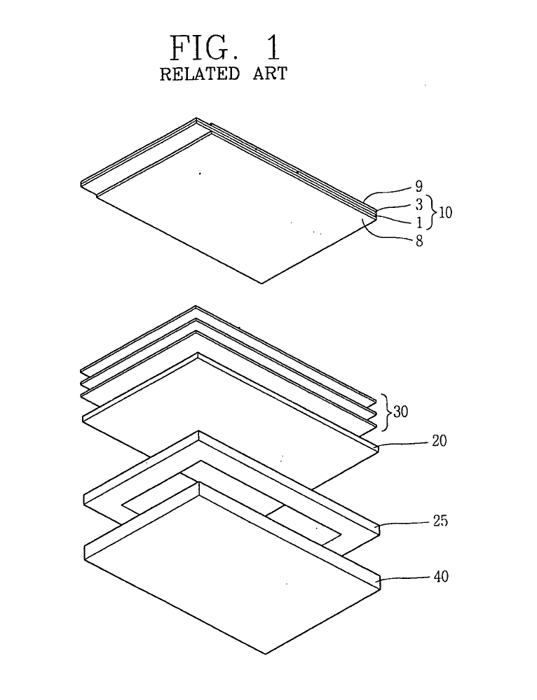

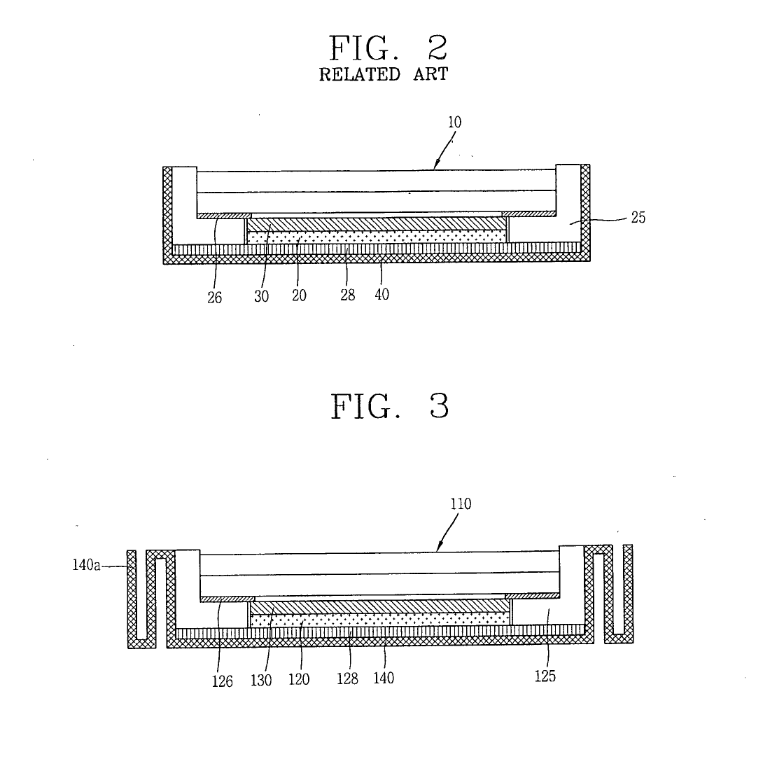

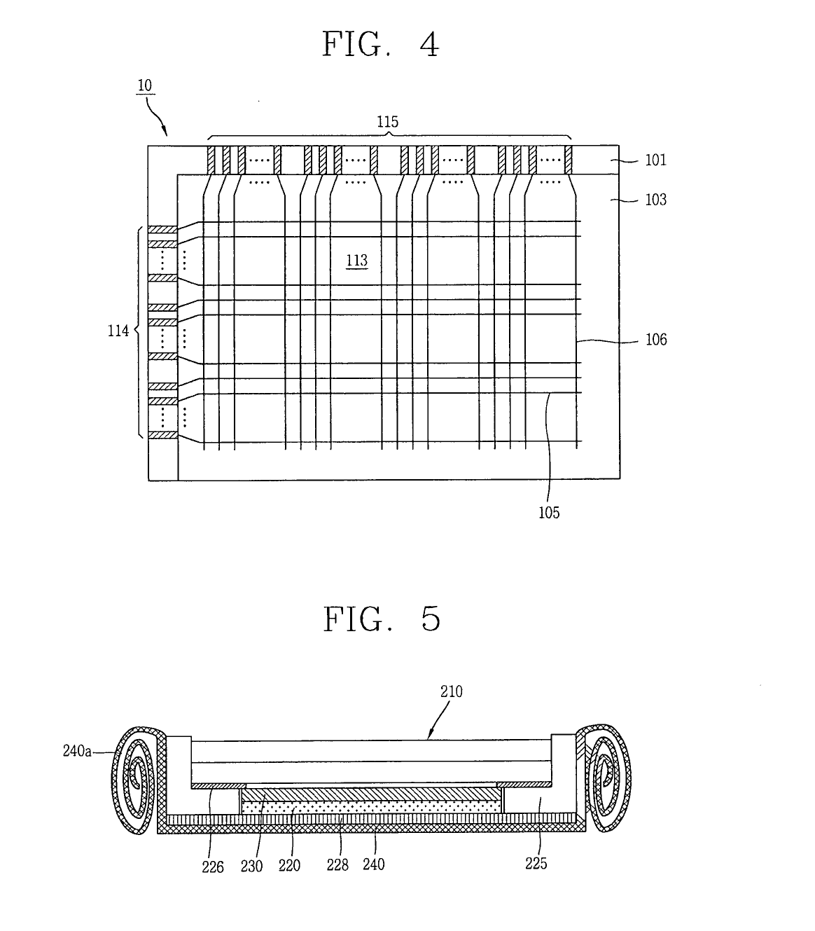

### DETAILED DESCRIPTION OF THE INVENTION

FIG. 3 is a sectional view showing the structure of a liquid crystal display (LCD) device according to one exemplary embodiment of the present invention.

As shown in FIG. 3, the LCD device according to an exemplary embodiment includes: a liquid crystal display panel 110, a light guide plate 120 disposed below the liquid crystal display panel 110 and guide light emitted from a light source (not shown) such as a light emitting diode (LED) or a lamp so as to be supplied to the liquid crystal display panel 110, an optical sheet 130 provided between the liquid crystal display panel 110 and the light guide plate 120 to diffuse and condense light supplied to the liquid crystal display panel after being guided from the light guide plate 120 to thus improve light efficiency, a main support unit 125 disposed under the light guide plate 120 to support the light guide plate 120 and the liquid crystal display panel 110, and a lower cover 140 allowing the liquid crystal display panel 110, the light guide plate 120, the optical sheet 130, and the main support unit 125 to be accommodated and assembled therein.

An end portion of the lower cover 140 extends to form a bent portion 140a bent to an outer side of the liquid crystal display panel 110. The bent portion 140a is bent at least once, and preferably, three or four times to the outer side of the liquid crystal display panel 110. In FIG. 3, the bent portion 140a is bent with a length similar to the length of the lower cover 140 at the side of the LCD device, but the bent length of the portion 140a may be smaller than the length of the side of the lower cover 140.

Accordingly, as the lower cover 140 extends to form the bent portion 140, a transfer of an eternal impact, which has been applied to the LCD, to the liquid crystal display panel 110 can be interrupted. Namely, because the external impact is absorbed by the bent portion 140, the liquid crystal display panel 110 can be prevented from being damaged by the external impact.

The liquid crystal display panel 110 includes an image display part 113 in which a plurality of gate lines 105 and a plurality of data lines 106 cross horizontally and vertically to define a plurality of pixels arranged in a matrix form, and a gate pad part 114 connected with the gate lines 105 of the image display part 113, and a data pad part 115 connected with the data lines 106. The gate pad part 114 and the data pad part 115 are formed at the edges of the first substrate 101 not overlapping with the second substrate 103 on which color filters (not shown) are formed. The gate pad part 114 supplies scan signals supplied from a gate driver integrated circuit (IC) to the gate lines of the image display part 113, and the data pad part 115 supplies image information supplied from a data driver IC to the data lines of the image display part 113.

Although not shown, the first substrate 101 of the image display part 113 includes a thin film transistor (TFT) is formed at each crossing of the data lines 106 to which the image signal is applied and the gate lines 105 to which the scan signal is applied, a pixel electrode connected with the TFT to drive liquid crystal molecules of the liquid crystal layer, and a protection layer formed on the entire surface of the first substrate 101 to protect the electrode and the TFTs.

The second substrate 103 of the image display part 113 includes color filters coated at each pixel area by being divided by black matrixes and a transparent common electrode formed on the first substrate 101.

As described above, a certain cell gap is maintained between the first and second substrates 101 and 103, and the first and second substrates 101 and 103 are attached by a sealing part (not shown) formed at the edges of the image display part 113. A liquid crystal layer (not shown) is formed at a space between the first and second substrates 101 and 103.

The light guide plate 120 is disposed on a reflector 128 formed on the lower cover 140 to guide light made incident from the light source toward the liquid crystal display panel 110, and light made incident from the bottom surface of the lower cover 140 is reflected by the reflector 128 and then supplied to the liquid crystal display panel 110 through the light guide plate 120.

Although not shown, an LED or a fluorescent lamp is used as the light source. When the LED is used, a plurality of LEDs may be disposed along one side of the light guide plate 120 such that they face the side of the light guide plate 120, so light is made incident through the side of the light guide plate 120. In addition, when a fluorescent lamp is used, it may be disposed at one side or at both sides of the light guide late 128 to provide light to the liquid crystal display panel 110 through the light guide plate 120. In this case, a lamp housing may be formed at the main support unit 125 at the side of the light guide plate 120 to accommodate the lamp.

Although not shown, the optical sheet 130 includes a diffusion sheet for diffusing light made incident from the light guide plate 120, a prism sheet for making the diffused light to proceed to the front side, and a protection sheet for protecting the diffusion sheet and the prism sheet, to thereby constantly provide uniform light to the liquid crystal display panel 110.

The main support unit 125 fixedly supports the liquid crystal display panel 110, the light guide plate 120, and the optical sheet 130. As illustrated the main support unit 125 is formed to the outer surface of the liquid crystal display panel 110 and the side of the liquid crystal display panel 110 is in contact with the main support unit 125, but the main support unit 125 may be formed only at the lower portion of the liquid crystal display panel 110 and the side of the liquid crystal display panel 100 may be directly in contact with the lower cover 140.

As illustrated, the liquid crystal display panel 110 is placed on the pad 126 formed on the upper surface of the main support unit 125, and the light guide plate 120 and the optical sheet 130 are placed on the lower cover 140. However, the optical sheet 130 may be placed on the main support unit 125. In this case, the optical sheet 130 and the liquid crystal display panel 110 may be spaced apart from each other.

As described above, in the present invention, the lower cover 140 extends to be bent to the outer side of the LCD device to form the bent portion 140a to thereby prevent the liquid crystal display panel 110 from being damaged by an external impact. In this case, the bent portion 140a may be bent to the inner side of the LCD device, namely, toward the side where the liquid crystal display panel 110, but preferably, the bent portion 140a is bent to the outer side for the following reasons.

That is, if the lower cover 140 is bent to the inner side, the length of the bent portion 140a is limited. Namely, if the bent portion 140a is so lengthy as to be in contact with the inner bottom surface of the lower cover 140, the lower cover 140 may be damaged or a foreign material or debris may be generated. Thus, if the lower cover 140 is inwardly bent, the length of the bent portion 140a would be shortened to fail to perfectly absorb an external impact.

In addition, if the lower cover 140 is bent inwardly, it is not possible to bend the lower cover 140 as many times as possible. The inner side of the lower cover 140 is a space in which the liquid crystal display panel 110 and various components are accommodated. Thus, if the lower cover 140 is inwardly bent, the internal space of the lower cover 140 should be extended as wide as the number of bending times of the lower cover 140, resulting in an increase in the size of the LCD device. In addition, it is more difficult to inwardly bend the lower cover 140 than to outwardly bend the lower cover 140. Thus, if the lower cover 140 is inwardly bent, because the number of times of being is limited, it cannot perfectly absorb an external impact.

In this respect, however, in the present invention, because the lower cover 140 is outwardly bent, the lower cover 140 can be bent by a desired number of times (e.g., three or four times). Of course, the present invention is not limited to the structure in which the lower cover 140 is outwardly bent, and may include the structure in which the lower cover is inwardly bent.

Meanwhile, as described above, because the lower cover 140 is outwardly bent, the inner side of the lower cover 140 forms a flat plane. In FIG. 3, the main support unit 125 is disposed between the surface of the lower cover 140 and the liquid crystal display panel 110 to fix the liquid crystal display panel 110, but an inner surface of the lower cover 140 may be directly in contact with the liquid crystal display panel 110 to fix the liquid crystal display panel.

In FIG. 3, there is no any structure at an upper portion of the liquid crystal display panel 110, but an upper cover may be provided at the upper portion of the liquid crystal display panel 110, and in this case, the upper cover may be coupled with the lower cover 140.

In the present invention, the number of times of bending of the lower cover or the shape of the bending may not be limited. The number of times of bending or the shape of the bent portion 140a are described for the sake of brevity, and the present invention is not limited thereto. In the present invention, the number of times of bending or the shape of the bent portion vary depending on the conditions such as the size or the like of the LCD device, and the bent portion may be bent any number of times or may have any shape so long as an impact applied from the exterior can be effectively absorbed.

FIG. 5 is a sectional view showing the structure of an LCD device according to another exemplary embodiment. In the LCD device according to the present exemplary embodiment, a bent portion 240a of a lower cover 240 is wound outwardly at least several times. Because the bent portion 240a has an ellipse shape, an impact applied from the exterior can be absorbed by the ellipse bent portion 240a, without being applied to a liquid crystal display panel 210. In this case, the bent portion 240a may be bent in the ellipse shape several times depending on the size or the like of the liquid crystal display panel 210. In addition, the bent portion 240a may have various other shapes such as a circular shape, as well as the ellipse shape.

As the present invention may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A liquid crystal display (LCD) device comprising:
a liquid crystal display panel;
a light source below the liquid crystal display panel and emitting light to supply the light to the liquid crystal display panel;
a light guide plate below the liquid crystal display panel to guide the light emitted from the light source to the liquid crystal display panel;
a lower cover for receiving and assembling the liquid crystal display panel, the light source and the light guide plate; and
a bent portion extending from an end portion of the lower cover and bent toward an outer side of the liquid crystal display panel at least once to absorb an impact applied from an exterior.

2. The device of claim 1, wherein the bent portion is bent in a quadrangular shape.

3. The device of claim 2, wherein the bent portion is bent three or four times.

4. The device of claim 1, wherein the bent portion is bent in a circular or ellipse shape.

5. The device of claim 1, wherein the length of the bent portion is substantially equal to the length of a side of the lower cover.

6. The device of claim 1, wherein a side of the lower cover is directly in contact with the liquid crystal display panel.

7. The device of claim 1, further comprising:
a upper cover installed above the liquid crystal display panel and coupled with the lower cover.
